(19) United States
(12) Patent Application Publication
(10) Pub. No.: US 2011/0297618 A1
(43) Pub. Date: Dec. 8, 2011

(54) Filtering Process and System to Remove AlCl3 Particulates from Ionic Liquid

(75) Inventors: Huping LUO, San Ramon, CA (US); Moinuddin AHMED, San Ramon, CA (US); Kris PARIMI, San Ramon, CA (US); Bong-Kyu CHANG, San Ramon, CA (US); Sara LINDSAY, San Ramon, CA (US)

(73) Assignee: CHEVRON U.S.A. INC., San Ramon, CA (US)

(21) Appl. No.: 13/211,559

(22) Filed: Aug. 17, 2011

Related U.S. Application Data
(62) Division of application No. 12/324,589, filed on Nov. 26, 2008.

(51) Int. Cl. C02F 1/42; B01D 29/00

(52) U.S. Cl. 210/681; 210/323.1

(57) ABSTRACT

A process for the filtration of an ionic liquid involves feeding an ionic liquid containing precipitated metal halides to a first filtering zone, which includes at least one first filter, to provide a partially filtered product. The process further includes subsequently feeding the partially filtered product to a second filtering zone, which includes at least one second filter having a smaller pore size than the at least one first filter, to provide a filtered product. A filter system capable of filtering precipitated metal halides from ionic liquid is also disclosed.

### RELATED APPLICATIONS

The present application is a divisional of U.S. patent application Ser. No. 12/324,589, filed Nov. 26, 2008, the contents of which are hereby incorporated in their entirety.

### FIELD OF ART

The process and system as described herein relate to filtering precipitated metal halides out of ionic liquid to provide filtered ionic liquid. More particularly, the process and system as described herein relate to filtering precipitated metal halides out of regenerated ionic liquid catalyst to provide filtered, regenerated ionic liquid catalyst.

### BACKGROUND

An alkylation process, which is disclosed in U.S. Pat. No. 7,432,408 (“the '408 patent”), involves contacting isoparaffins, preferably isopentane, with olefins, preferably ethylene, in the presence of an ionic liquid catalyst to produce gasoline blending components. The contents of the '408 patent are incorporated by reference herein in its entirety.

An ionic liquid catalyst distinguishes this novel alkylation process from conventional processes that convert light paraffins and light olefins to more lucrative products such as the alkylation of isoparaffins with olefins and the polymerization of olefins. For example, two of the more extensively used processes to alkylate isobutane with C₃-O₅ olefins to make gasoline cuts with high octane numbers use sulfuric acid (H₂SO₄) and hydrofluoric acid (HF) catalysts.

Ionic liquid catalysts specifically useful in the alkylation process described in the '408 patent are disclosed in U.S. Patent Application Publication 2006/0135839 (“the '839 publication”), which is also incorporated by reference in its entirety herein. Such catalysts include a chloroaluminate ionic liquid catalyst comprising a hydrocarbyl substituted pyridinium halide and aluminum trichloride or a hydrocarbyl substituted imidazolium halide and aluminum trichloride. Such catalysts further include chloroaluminate ionic liquid catalysts comprising an alkyl substituted pyridinium halide and aluminum trichloride or an alkyl substituted imidazolium halide and aluminum trichloride. Preferred chloroaluminate ionic liquid catalysts include 1-butyl-4-methyl-pyridinium chloroaluminate (BMP), 1-butyl-pyridinium chloroaluminate (BP), 1-butyl-3-methyl-imidazolium chloroaluminate (BMIM) and 1-H-pyridinium chloroaluminate (HP).

As a result of use, ionic liquid catalysts can become deactivated, i.e. lose activity, and may eventually need to be replaced. Alkylation processes utilizing an ionic liquid catalyst can form by-products known as conjunct polymers. These conjunct polymers generally deactivate the ionic liquid catalyst by forming complexes with the ionic liquid catalyst. Conjunct polymers are highly unsaturated molecules and can complex the Lewis acid portion of the ionic liquid catalyst via their double bonds. For example, as aluminum trichloride in aluminum trichloride-containing ionic liquid catalysts becomes complexed with conjunct polymers, the activity of these ionic liquid catalysts becomes impaired or at least compromised. Conjunct polymers may also become chlorinated and through their chloro groups may interact with aluminum trichloride in aluminum trichloride-containing catalysts and therefore reduce the overall activity of these catalysts or lessen their effectiveness as catalysts for their intended purpose.

Deactivation of ionic liquid catalysts by conjunct polymers is not only problematic for alkylation chemistry, but also effects the economic feasibility of using ionic liquid catalysts as they are expensive to replace. Therefore, commercial exploitation of ionic liquid catalysts in alkylation is economically infeasible unless they can be efficiently regenerated and recycled.

U.S. patent application Ser. No. 12/003,578 (“the '578 application”) is directed to a process for regenerating an ionic liquid catalyst which has been deactivated by conjunct polymers. The process comprises the steps of (a) providing an ionic liquid catalyst, wherein at least a portion of the ionic liquid catalyst is bound to conjunct polymers; (b) reacting the ionic liquid catalyst with aluminum metal to free the conjunct polymers from the ionic liquid catalyst in a stirred reactor or a fixed bed reactor; and (c) separating the freed conjunct polymers from the catalyst phase by solvent extraction in a stirred or packed extraction column. The contents of the '578 application are incorporated by reference herein in their entirety.

In order to provide regenerated ionic liquid catalyst, in the process of the '578 application, spent ionic liquid catalyst reacts with aluminum metal. If the spent ionic liquid catalyst is a chloroaluminate ionic liquid catalyst, such as catalysts disclosed in the '839 publication, it produces aluminum trichloride (AlCl₃) as a byproduct. The AlCl₃ byproduct can remain dissolved in the regenerated catalyst. Accordingly, it is necessary to separate the regenerated catalyst and the AlCl₃ byproduct so that the regenerated catalyst can be recycled to the alkylation step.

One method of separating the regenerated ionic liquid catalyst and the AlCl₃ byproduct is disclosed in a U.S. Patent Application entitled “A Process to Remove Dissolved AlCl₃ from Ionic Liquid,” which is being filed concurrently with the present application. This application is incorporated by reference herein in its entirety. The application relates to a process for removing metal halides from an ionic liquid, comprising causing the metal halides to precipitate out of the ionic liquid. Precipitation may result from cooling, which forms metal halide seed crystals. Precipitation may also result from providing metal halide seed crystals, with or without cooling.

After precipitated metal halides form, they remain dispersed in a bulk phase of the ionic liquid. It is desirable to remove the precipitated metal halides from the ionic liquid in order to re-use the ionic liquid. In regard to the alkylation process discussed above, it is desirable to remove the precipitated AlCl₃ from the regenerated ionic liquid catalyst in order to recycle the regenerated ionic liquid catalyst to the alkylation process. Accordingly, there is a need for a process that effectively and efficiently separates the precipitated AlCl₃ from the regenerated ionic liquid catalyst.

Known separation techniques for separating solid particles from liquids can be used to separate the precipitated AlCl₃ from the regenerated ionic liquid catalyst. Such known separation techniques include decantation and filtration. However, decantation and filtration can suffer from severe disadvantages. Decantation may require an impractically long residence time. In regard to filtration, fines of precipitated AlCl₃ may remain in the regenerated ionic liquid catalyst if the filter is not of the proper size. Moreover, a filter may become clogged or blocked often increasing the pressure drop across the filter to an undesirable level. Removing the blockage requires shutting down the filtration process and even the entire alkylation process.

During shut down, it is possible to clean one or more filters in the filtration process. However, such cleaning during shut down is also problematic. The ionic liquid catalyst is very sensitive to air and moisture. Exposure of the ionic liquid to the atmosphere when a cartridge filter, for example, is removed for cleaning, can damage the ionic liquid.

Therefore, there is a need for a separation process and system for removing precipitated AlCl₃ from regenerated ionic liquid catalyst. The separation process and system should remove precipitated AlCl₃ from the regenerated ionic liquid catalyst to provide filtered, regenerated ionic liquid catalyst. The separation process and system should minimize the occurrence of blockages and pressure drop problems. Additionally, the separation process and system should be able to overcome the occurrence of blockages and pressure drop problems such that it is suited for continuous operation. Furthermore, it is especially desirable if the separation process and system has the ability to eliminate or limit exposure of the ionic liquid catalyst to the atmosphere. In general, the process and system should be simple and efficient enough to be used to separate any precipitated metal halide from an ionic liquid.

### BRIEF DESCRIPTION OF THE DRAWINGS

FIG. 1 is a schematic illustration depicting an embodiment of a process for the continuous filtration of an ionic liquid as disclosed herein.

FIG. 2 is a schematic illustration depicting an embodiment of a continuously operable filter system as disclosed herein.

### SUMMARY

A process for the filtration of an ionic liquid is disclosed herein. In one embodiment, the process comprises: feeding an ionic liquid containing precipitated metal halides to a first filtering zone to provide a partially filtered product; and feeding the partially filtered product to a second filtering zone to provide a filtered product, wherein the first filtering zone comprises at least one first filter and the second filtering zone comprises at least one second filter, and the at least one second filter has a smaller pore size than the at least one first filter.

Also disclosed herein is a filter system. In one embodiment, the system comprises: a first filtering zone, wherein an ionic liquid containing precipitated metal halides is filtered to provide a partially filtered product; and a second filtering zone, wherein the partially filtered product is filtered to provide a filtered product, the second filtering zone being in fluid communication with the first filtering zone, wherein the first filtering zone comprises at least one first filter and the second filtering zone comprises at least one second filter, and the at least one second filter has a smaller pore size than the at least one first filter.

Among other factors, the process and system as described herein can efficiently and effectively provide filtered ionic liquid. The process and system as described herein can maintain overall pressure drop at a reasonably low level over a longer period of time. Accordingly, the process and system can minimize the occurrence of blockages and pressure drop problems. In one embodiment, the process and system as described herein can overcome the occurrence of blockages and pressure drop problems to operate continuously. In some embodiments, by using specific types of filters, the process and system as described herein can ensure that any damage to the ionic liquid, by exposure to air and moisture, is minimal.

### DETAILED DESCRIPTION

A specially designed process and system for removing precipitated metal halides from ionic liquid by filtration are disclosed herein. Such process and system are advantageous because they can filter precipitated metal halides from ionic liquid to provide filtered ionic liquid. The overall pressure drop across the filtration process and system can also be maintained at a reasonably low level and, therefore, minimize the occurrence of blockages and undesirable pressure drop increases in the process and system. By using filters configured in parallel, the process and system can overcome the occurrence of blockages and pressure drop problems and, therefore, permit continuous filtration of the precipitated metal halides. By using specific types of filters, the process and system can even protect the ionic liquid from undesirable conditions, namely air and moisture.

### Process for the Filtration of an Ionic Liquid

The process involves first feeding an ionic liquid containing precipitated metal halides to a first filtering zone to provide a partially filtered product. The partially filtered product is an ionic liquid containing significantly less precipitated metal halides than the ionic liquid fed to the first filtering zone. The process further involves feeding the partially filtered product to a second filtering zone to provide a filtered product. The filtered product is an ionic liquid containing significantly less precipitated metal halides than the partially filtered product.

Each filtering zone includes at least one filter. More specifically, the first filtering zone includes at least one first filter and the second filtering zone includes at least one second filter. As used herein, the term “filtered product” refers to an ionic liquid that has been filtered by the at least one first filter and the at least one second filter.

It is important that the at least one second filter has a smaller pore size than the at least one first filter. When the ionic liquid passes through the at least one first filter, the larger pore size of the at least one first filter removes the larger precipitated metal halides. Subsequently, when the ionic liquid passes through the at least one second filter, the smaller pore size of the at least one second filter removes smaller particles of precipitated metal halides that are not detained by the at least one first filter. Accordingly, the first filtering zone removes relatively large precipitated metal halides from ionic liquid and the second filtering zone removes finer particles of precipitated metal halides.

This combination of filters is advantageous because it can maintain a relatively low pressure drop across the filters for a longer period of time. Pressure drop across a filter depends upon pore size and the amount of solid or precipitate accumulated in the filter. Due to larger pore size, the pressure drop across the first filtering zone is inherently lower than the pressure drop across the second filtering zone. The amount of accumulation of solids or precipitate on the at least one first filter required for a given pressure drop increase is also more than the amount of accumulation on the at least one second filter required for the same pressure drop increase. Therefore, the pressure drop across the at least one second filter is more sensitive to build up of solid or precipitate. Since the at least one first filter removes some of the solid or precipitate, the at least one second filters accumulates less solid or precipitate. Thus, the overall pressure drop across the filters remains lower and, as solid or precipitate accumulates in the filters, pressure drop increases at a slower rate.

The larger pore size of the at least one first filter may also remove the bulk of the precipitated metal halides. In this manner, if the at least one first filter removes the bulk of the precipitated metal halides, the at least one first filter may be said to have “high solid capacity” or “high volume capacity.”

The first and second filtering zones can each include a series of filters in a parallel arrangement. In particular, the first filtering zone can include two or more first filters configured in parallel and the second filtering zone can similarly include two or more second filters configured in parallel. Parallel configuration of the filters in each filtering zone is advantageous because it permits continuous filtration.

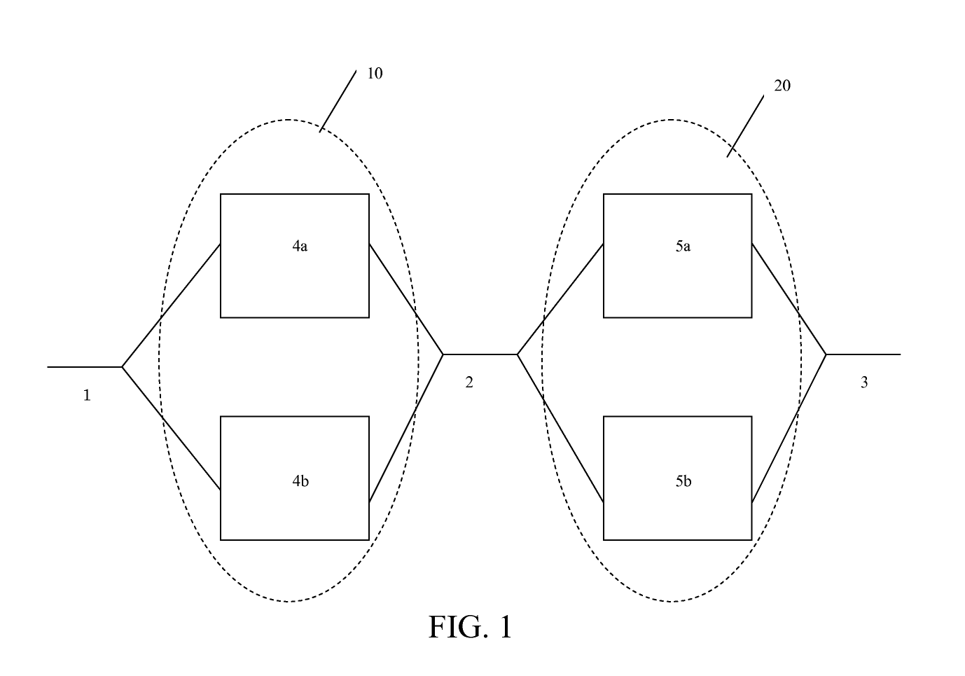

The advantage of continuous filtration can be better understood with reference to FIG. 1, which illustrates such parallel configuration of the first and second filters.

According to FIG. 1, an ionic liquid 1 containing precipitated metal halides arrives in a first filtering zone 10 comprised of first filters 4a, 4b. First filters 4a, 4b are arranged such that the ionic liquid 1 can flow through either or both of the first filters 4a, 4b. Upon exit from the first filtering zone 10, the ionic liquid is the partially filtered product 2. The partially filtered product 2 then arrives in a second filtering zone 10 comprised of second filters 5a, 5b. Like first filters 4a, 4b, second filters 5a, 5b are arranged such that the partially filtered product 2 can flow through either or both of the second filters 5a, 5b. Upon exit from the second filtering zone, the ionic liquid is the filtered product 3.

Continuous filtration of the ionic liquid, as illustrated in FIG. 1, is possible in the following manner.

The ionic liquid can be permitted to flow to the first filter 4a, but not the first filter 4b. Therefore, the first filter 4a alone produces the partially filtered product. When the first filter 4a becomes clogged with precipitated metal halides such that the pressure drop across the filter rises to a particular level, the ionic liquid can be permitted to flow to the first filter 4b and flow to the first filter 4a can be discontinued. Once flow to the first filter 4a is blocked, the first filter 4b alone produces the partially filtered product. During such time, the first filter 4a can be cleaned. When the first filter 4b becomes clogged with precipitated metal halides such that the pressure drop across the filter rises to a particular level, the ionic liquid can again be permitted to flow to the first filter 4a and flow to the first filter 4b can be discontinued. Once flow to the first filter 4b is blocked, the first filter 4a alone produces the partially filtered product. During such time, the first filter 4b can be cleaned. In this manner, the ionic liquid feed 1 can be switched between the first filters 4a, 4b to continuously filter the ionic liquid 1 and continuously provide the partially filtered product 2.

Similarly, the partially filtered product 2 can be permitted to flow to the second filter 5a, but not the second filter 5b. Therefore, the second filter 5a alone produces the filtered product. When the second filter 5a becomes clogged with precipitated metal halides such that the pressure drop across the filter rises to a particular level, the partially filtered product can be permitted to flow to the second filter 5b and flow to the second filter 5a can be discontinued. Once flow to the second filter 5a is blocked, the second filter 5b alone produces the filtered product. During such time, the second filter 5a can be cleaned. When the second filter 5b becomes clogged with precipitated metal halides such that the pressure drop across the filter rises to a particular level, the partially filtered product can again be permitted to flow to the second filter 5a and flow to the second filter 5b can be discontinued. During such time, the second filter 5b can be cleaned. In this manner, feed of the partially filtered product can be switched between the second filters 5a, 5b to continuously filter the partially filtered product 2 and continuously provide the filtered product 3.

When the present application refers to “cleaning” a filter, it refers to removing precipitated metal halide and any other material that has adhered to the filter thereby impeding and/or blocking fluid flow across the filter. The method by which the filters are cleaned depends upon the type of filter. For example, if a filter is a self-cleaning, back-flushable filter, it can be cleaned by back-flushing. However, if a filter is a cartridge filter, it can be cleaned by changing the cartridge.

The filtration process as disclosed herein is not limited to two filtering zones. The filtration process may include three, four, five, etc. filtering zones. Accordingly, additional filtering zones may be utilized downstream from the first filtering zone and the second filtering zone as desirable or necessary. While more filtering zones correspond to a greater capital cost for the process, additional filtering zones may be desirable or necessary so that the ionic liquid exiting the process may be free of metal halides, may exhibit an overall lower pressure drop, and may require fewer cleaning cycles of the individual filters.

The filtration process as disclosed herein is also not limited to using two first filters configured in parallel and two second filters configured in parallel. Three, four, five, etc. first filters may be configured in parallel in the first filtration zone. Similarly, three, four, five, etc. second filters may be configured in parallel in the second filtration zone. The number of filters in each filtering zone can be the same or different than the number of filters in other filtering zone(s).

The process as described herein is particularly useful for removing precipitated metal halides (e.g. AlCl₃) from regenerated ionic liquid catalyst.

A used or spent ionic liquid catalyst can be regenerated by contacting the used catalyst with a regeneration metal in the presence or absence of hydrogen. The metal selected for regeneration is based on the composition of the ionic liquid catalyst. The metal should be selected carefully to prevent the contamination of the catalyst with unwanted metal complexes or intermediates that may form and remain in the ionic liquid catalyst phase. The regeneration metal can be selected from Groups III-A, II-B or I-B. For example, the regeneration metal can be B, Al, Ga, In, Tl, Zn, Cd, Cu, Ag, or Au. The regeneration metal may be used in any form, alone, in combination or as alloys.

Regenerating an ionic liquid catalyst in this manner can form excess, dissolved metal halide in the regenerated ionic liquid catalyst. It is then necessary to remove this excess, dissolved metal halide from the regenerated catalyst before it can be recycled to the process utilizing the ionic liquid catalyst and in need of regenerated catalyst. Moreover, the metal halide must be removed to prevent it from accumulating in the regeneration zone and other parts of the regeneration unit and causing plugging problems.

For example, deactivated, or at least partially deactivated, chloroaluminate ionic liquid catalyst can be reacted with aluminum metal, in the presence or absence of hydrogen, to regenerate the chloroaluminate ionic liquid catalyst. However, the reaction with aluminum metal can form excess, dissolved AlCl₃ in the regenerated chloroaluminate ionic liquid catalyst. It is necessary to remove this excess, dissolved AlCl₃ prior to recycling the regenerated chloroaluminate ionic liquid catalyst to, for example, an alkylation reaction.

One method of removing the excess, dissolved metal halide (e.g. excess, dissolved AlCl₃) involves precipitating the excess, dissolved metal halide from the regenerated ionic liquid catalyst. However, after the excess, dissolved metal halide precipitates out of the regenerated ionic liquid catalyst, precipitated metal halides (e.g. precipitated AlCl₃) still remain in the catalyst. As such, it is necessary to remove the precipitated metal halides from the catalyst so that the catalyst may be recycled to the process it catalyzes.

Accordingly, the process for the filtration of an ionic liquid disclosed herein can be used to separate precipitated metal halides from regenerated ionic liquid catalyst. In order to use the process for such separation, the regenerated ionic liquid catalyst containing precipitated metal halides is fed to the first filtering zone to provide a partially filtered product, which is subsequently fed to the second filtering zone as discussed above.

### Filters

As discussed above, in the first and second filtering zones, the at least one second filter has a smaller pore size than the at least one first filter. Similarly, if there are additional filtering zones, the filters in each subsequent filtering zone can have a smaller pore size than the filters in the previous filtering zone.

The filters can be any type of filter known in the art. Filters that can be cleaned without exposing the ionic liquid to the atmosphere are particularly desirable. In general, ionic liquids are very sensitive to air and moisture. For this reason, it is useful to isolate an ionic liquid from the atmosphere. Accordingly, filters that permit cleaning without exposing the ionic liquid to the atmosphere are advantageous. A representative example of such a filter is a self-cleaning, back-flushing filter. A representative example of a filter than does not fall into this category is a cartridge filter.

Accordingly, in one embodiment, the at least one first filter is a self-cleaning, back-flushing filter. In another embodiment, the at least one second filter is self-cleaning, back-flushing filters. However, in another embodiment, the at least one second filter is a cartridge filter.

### Filtered Product

The product exiting the filtration process as disclosed herein, the filtered product, may have a zero or nearly zero content of precipitated metal halides. However, as discussed above, the filtered product refers to an ionic liquid that has been filtered by the at least one first filter and the at least one second filter.

### Filter System

Also disclosed herein is a filter system. Filtering of an ionic liquid containing precipitated metal halides to remove the precipitated metal halides from the ionic liquid is possible with such filter system.

In one embodiment, the filter system comprises a first filtering zone and a second filtering zone in fluid communication with the first filtering zone. The first filtering zone comprises at least one first filter and the second filtering zone comprises at least one second filter. The at least one second filter has a smaller pore size than the at least one first filter. An ionic liquid containing precipitated metal halides can be filtered in the first filtering zone to provide a partially filtered product, which can be filtered in the second filtering zone to provide a filtered product.

In a particular embodiment of the system, the first filtering zone can comprise two or more first filters configured in parallel, while the second filtering zone can comprise two or more second filters configured in parallel. However, the first filtering zone and the second filtering zone are configured in series.

In another embodiment of the system, the system can include a feed line leading to the two or more first filters and a partially filtered product line leaving the two or more first filters and leading to the two or more second filters. A first valve zone can be situated on the feed line and a second valve zone can be situated on the partially filtered product line. More specifically, the first valve zone can include two or more first valves and the second valve zone can include two or more second valves. Each first valve is disposed on the feed line and capable of blocking fluid flow to one of the first filters. Similarly, each second valve is disposed on the partially filtered product line and capable of blocking fluid flow to one of the second filters.

In operation, an ionic liquid containing precipitated metal halides can travel through the feed line to the two or more first filters to provide a partially filtered product and the partially filtered product can travel through the partially filtered product line to the two or more second filters to provide a filtered product. The first valves can be arranged so that the ionic liquid containing precipitated metal halides contacts only one of the first filters at a time and the second valves can be arranged so that the partially filtered product contacts only one of the second filters at a time.

Accordingly, while the ionic liquid containing precipitated metal halides is being filtered by the first filter it contacts, one or more of the additional first filters can be cleaned. Similarly, while the partially filtered product is being filtered by the second filter it contacts, one or more of the additional second filters can be cleaned. In this manner, the system as disclosed herein is capable of continuous filtration.

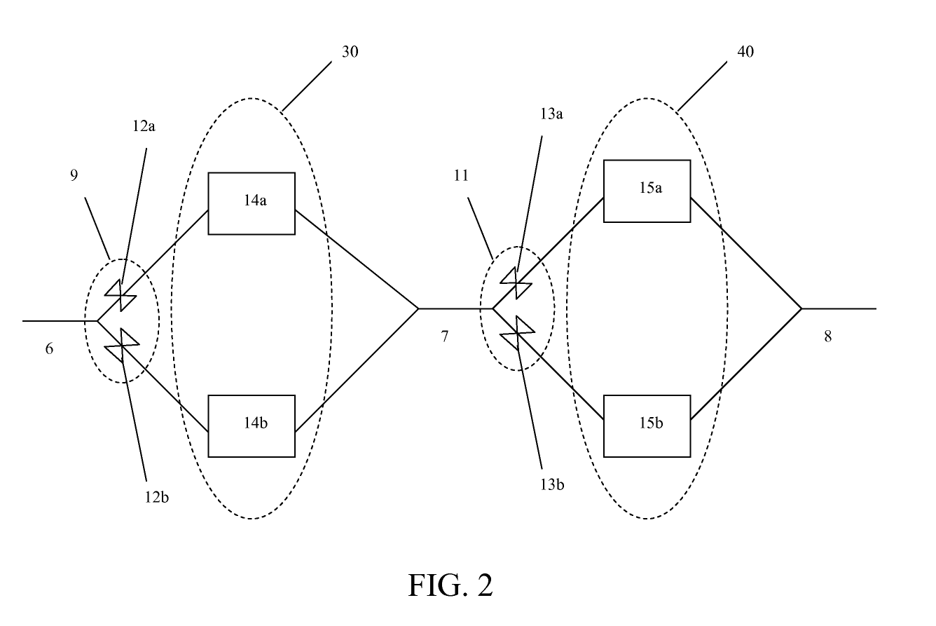

A representative embodiment of the filter system can be better understood with reference to FIG. 2.

As shown in FIG. 2, the filter system comprises a first filtering zone 30 and a second filtering zone 40 in fluid communication with the first filtering zone 30. The first filtering zone 30 comprises two first filters 14a, 14b configured in parallel and the second filtering zone 40 comprises two second filters 15a, 15b configured in parallel. The second filters 15a, 15b have a smaller pore size than the first filters 14a, 14b.

In use, the system operates such that the first filtering zone 30 filters an ionic liquid 6 containing precipitated metal halides to provide a partially filtered product 7 and the second filtering zone 40 filters the partially filtered product 7 to provide a filtered product 8.

The system of FIG. 2 includes a feed line 6 and a partially filtered product line 7. The feed line 6 leads to the first filters 14a, 14b of the first filtering zone 30. The partially filtered product line 7 leaves the first filters 14a, 14b and leads to the second filters 15a, 15b of the second filtering zone 40. The system of FIG. 2 also includes two valve zones, a first valve zone 9 and a second valve zone 11. A first valve zone 9 is on the feed line 6 and the second valve zone 11 is on the partially filtered product line 7 as it enters the second filters 15a, 15b. The system of FIG. 2 further includes two first valves 12a, 12b in the first valve zone 9 and two second valves 13a, 13b in the second valve zone 11. Each of the first valves 12a, 12b is disposed on the feed line 6 and capable of blocking fluid flow to one of the first filters 14a, 14b. First valve 12a is capable of blocking fluid flow to the first filter 14a and first valve 12b is capable of blocking fluid flow to the first filter 14b. Each of the second valves 13a, 13b is disposed on the partially filtered product line 7 and capable of blocking fluid flow to one of the second filters 15a, 15b. Second valve 13a is capable of blocking fluid flow to the second filter 15a and second valve 13b is capable of blocking fluid flow to the second filter 15b.

In operation, an ionic liquid containing precipitated metal halides can be filtered by first filters 14a, 14b depending upon whether valves 12a, 12b are open or closed. Likewise, the partially filtered product exiting the first filtering zone 30 in the partially filtered product line 7 can be filtered by second filters 15a, 15b depending upon whether valves 13a, 13b are open or closed. The valves 12a, 12b in the first valve zone 9 permit switch of flow between the first filters 14a, 14b and the valves 13a, 13b in the second valve zone 11 permit switch of flow between the second filters 15a, 15b. Accordingly, the system can continuously filter ionic liquid containing precipitated metal halides even if one of the first filters 14a, 14b or one of the second filters 15a, 15b is not in operation.

As with the process as disclosed herein, the filter system is not limited to two filtering zones. The filter system may include three, four, five, etc. filtering zones. Accordingly, additional filtering zones may be utilized downstream from the first filtering zone and the second filtering zone as desirable or necessary.

Also, as with the process as disclosed herein, the filter system is not limited to two first filters configured in parallel and two second filters configured in parallel. Three, four, five, etc. first filters may be configured in parallel in the first filtration zone. Similarly, three, four, five, etc. second filters may be configured in parallel in the second filtration zone. The number of filters in each filtering zone can be the same or different than the number of filters in other filtering zone(s).

The filter system as described herein is not limited to two valve zones for directing flow within the various filtering zones. The system may include three, four, five, etc. valve zones, where the number of valve zones corresponds to the number of filtering zones.

### Ionic Liquid

As used herein, the term “ionic liquids” refers to liquids that are composed entirely of ions as a combination of cations and anions. The term “ionic liquids” includes low-temperature ionic liquids, which are generally organic salts with melting points under 100° C. and often even lower than room temperature.

Ionic liquids may be suitable, for example, for use as a catalyst and as a solvent in alkylation and polymerization reactions as well as in dimerization, oligomerization, acetylation, olefin metathesis, and copolymerization reactions. The present embodiments are useful with regard to any ionic liquid catalyst.

One class of ionic liquids is fused salt compositions, which are molten at low temperature and are useful as catalysts, solvents, and electrolytes. Such compositions are mixtures of components, which are liquid at temperatures below the individual melting points of the components.

The most common ionic liquids are those prepared from organic-based cations and inorganic or organic anions. The most common organic cations are ammonium cations, but phosphonium and sulphonium cations are also frequently used. Ionic liquids of pyridinium and imidazolium are perhaps the most commonly used cations. Anions include, but are not limited to, BF₄⁻, PF₆⁻, haloaluminates such as Al₂Cl₇⁻ and Al₂Br₇⁻, [(CF₃SO₂)₂N]⁻, alkyl sulphates (RSO₃⁻), carboxylates (RCO₂⁻) and many others. The most catalytically interesting ionic liquids for acid catalysis are those derived from ammonium halides and Lewis acids (such as AlCl₃, TiCl₄, SnCl₄, FeCl₃, etc.). Chloroaluminate ionic liquids are perhaps the most commonly used ionic liquid catalyst systems for acid-catalyzed reactions.

Examples of such low temperature ionic liquids or molten fused salts are the chloroaluminate salts. Alkyl imidazolium or pyridinium chlorides, for example, can be mixed with aluminum trichloride (AlCl₃) to form the fused chloroaluminate salts.

In one embodiment, the ionic liquid is an ionic liquid catalyst. The process as described herein can employ a catalyst composition comprising at least one aluminum halide such as aluminum chloride, at least one quaternary ammonium halide and/or at least one amine halohydrate, and at least one cuprous compound. Such a catalyst composition and its preparation is disclosed in U.S. Pat. No. 5,750,455, which is incorporated by reference in its entirety herein.

Alternatively, the ionic liquid catalyst can be a chloroaluminate ionic liquid catalyst. For example, the ionic liquid catalyst can be a pyridinium or imidazolium-based chloroaluminate ionic liquid. These ionic liquids have been found to be much more effective in the alkylation of isopentane and isobutane with ethylene than aliphatic ammonium chloroaluminate ionic liquid (such as tributyl-methyl-ammonium chloroaluminate). The ionic liquid catalyst can be (1) a chloroaluminate ionic liquid catalyst comprising a hydrocarbyl substituted pyridinium halide of the general formula A below and aluminum trichloride or (2) a chloroaluminate ionic liquid catalyst comprising a hydrocarbyl substituted imidazolium halide of the general formula B below and aluminum trichloride. Such a chloroaluminate ionic liquid catalyst can be prepared by combining 1 molar equivalent hydrocarbyl substituted pyridinium halide or hydrocarbyl substituted imidazolium halide with 2 molar equivalents aluminum trichloride. The ionic liquid catalyst can also be (1) a chloroaluminate ionic liquid catalyst comprising an alkyl substituted pyridinium halide of the general formula A below and aluminum trichloride or (2) a chloroaluminate ionic liquid catalyst comprising an alkyl substituted imidazolium halide of the general formula B below and aluminum trichloride. Such a chloroaluminate ionic liquid catalyst can be prepared by combining 1 molar equivalent alkyl substituted pyridinium halide or alkyl substituted imidazolium halide to 2 molar equivalents of aluminum trichloride.

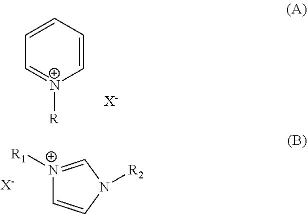

wherein R=H, methyl, ethyl, propyl, butyl, pentyl or hexyl group and X is a haloaluminate, and R₁ and R₂=H, methyl, ethyl, propyl, butyl, pentyl, or hexyl group and where R₁ and R₂ may or may not be the same. In one embodiment, the haloaluminate is a chloroaluminate.

The ionic liquid catalyst can also be mixtures of these chloroaluminate ionic liquid catalysts. Preferred chloroaluminate ionic liquid catalysts are 1-butyl-4-methyl-pyridinium chloroaluminate (BMP), 1-butyl-pyridinium chloroaluminate (BP), 1-butyl-3-methyl-imidazolium chloroaluminate (BMIM), 1-H-pyridinium chloroaluminate (HP), and N-butylpyridinium chloroaluminate (C₅H₅NC₄H₉Al₂Cl₇), and mixtures thereof.

In one embodiment, the ionic liquid containing precipitated metal halides can be selected from the group consisting of an alkyl-pyridinium chloroaluminate, a di-alkyl-imidazolium chloroaluminate, a tetra-alkyl-ammonium chloroaluminate, and mixtures thereof.

A metal halide may be employed as a co-catalyst to modify the catalyst activity and selectivity. Commonly used halides for such purposes include NaCl, LiCl, KCl, BeCl₂, CaCl₂, BaCl₂, SiCl₂, MgCl₂, PbCl₂, CuCl, ZrCl₄, and AgCl as published by Roebuck and Evering (Ind. Eng. Chem. Prod. Res. Develop., Vol. 9, 77, 1970), which is incorporated by reference in its entirety herein. Especially useful metal halides are CuCl, AgCl, PbCl₂, LiCl, and ZrCl₄. Another useful metal halide is AlCl₃.

HCl or any Broensted acid may be employed as an effective co-catalyst to enhance the activity of the catalyst by boosting the overall acidity of the ionic liquid-based catalyst. The use of such co-catalysts and ionic liquid catalysts that are useful in practicing the present process are disclosed in U.S. Published Patent Application Nos. 2003/0060359 and 2004/0077914, the disclosures of which are herein incorporated by reference in their entirety. Other co-catalysts that may be used to enhance the catalytic activity of the ionic liquid catalyst include IVB metal compounds preferably IVB metal halides such as TiCl₃, TiCl₄, TiBr₃, TiBr₄, ZrCl₄, ZrBr₄, HfC₄, and HfBr₄ as described by Hirschauer et al. in U.S. Pat. No. 6,028,024, which document is incorporated by reference in its entirety herein.

The ionic liquid fed to the first filtering zone can include greater than about 0.01 weight %, such as between about 0.05 weight % and about 1 weight %, precipitated metal halides.

Although the present process and system have been described in connection with specific embodiments thereof, it will be appreciated by those skilled in the art that additions, deletions, modifications, and substitutions not specifically described may be made without departing from the spirit and scope of the process and system as defined in the appended claims.

That which is claimed is:

1. A filter system for the filtration of an ionic liquid which limits exposure of the ionic liquid to air and moisture, comprising:
a first filtering zone, wherein an ionic liquid containing precipitated metal halides is filtered to provide a partially filtered product; and
a second filtering zone, wherein the partially filtered product is filtered to provide a filtered product, the second filtering zone being in fluid communication with the first filtering zone,
wherein the first filtering zone comprises at least one first filter and the second filtering zone comprises at least one second filter, and the at least one second filter has a smaller pore size than the at least one first filter.

2. The filter system according to claim 1, wherein the first filtering zone comprises two or more first filters configured in parallel.

3. The filter system according to claim 1, wherein the second filtering zone comprises two or more second filters configured in parallel.

4. The filter system according to claim 2, wherein the second filtering zone comprises two or more second filters configured in parallel.

5. The filter system according to claim 4, further comprising:
a feed line leading to the two or more first filters, wherein the ionic liquid containing precipitated metal halides is fed to the two or more first filters to provide the partially filtered product; and
a partially filtered product line leaving the two or more first filters and leading to the two or more second filters, wherein the partially filtered product is fed to the two or more second filters to provide the filtered product.

6. The filter system according to claim 5, further comprising:
a first valve zone comprising two or more first valves, each first valve being disposed on the feed line and capable of blocking fluid flow to one of the first filters; and
a second valve zone comprising two or more second valves, each second valve being disposed on the partially filtered product line and capable of blocking fluid flow to one of the second filters.

7. The filter system according to claim 1, wherein the at least one first filter is a self-cleaning, back-flushing filter.

8. The filter system according to claim 1, wherein the at least one second filter is a self-cleaning, back-flushing filter.

9. The filter system according to claim 7, wherein the at least one second filter is a self-cleaning, back-flushing filter.

10. The filter system according to claim 1, wherein the at least one first filter is a self-cleaning, back-flushing filter and the at least one second filter is a cartridge filter.

11. The filter system according to claim 1, wherein the ionic liquid containing precipitated metal halides is selected from the group consisting of an alkyl-pyridinium chloroaluminate, a di-alkyl-imidazolium chloroaluminate, a tetra-alkyl-ammonium chloroaluminate, and mixtures thereof.

12. The filter system according to claim 1, wherein the ionic liquid is not exposed to the air or moisture.

13. The filter system according to claim 1, wherein the first filtering zone removes the bulk of the precipitated metal halides.

14. The filter system according to claim 1, wherein the precipitated metal halides are precipitated AlCl₃.

15. The process according to claim 1, wherein the ionic liquid fed to the first filtering zone comprises greater than about 0.01 weight % precipitated metal halides.

16. The process according to claim 15, wherein the ionic liquid fed to the first filtering zone comprises between about 0.05 weight % and about 1 weight % precipitated metal halides.
